(19) United States
(12) Patent Application Publication
(10) Pub. No.: US 2013/0111928 A1
(43) Pub. Date: May 9, 2013

(54) Gas bubble agitated liquid bath heat exchange process and apparatus

(71) Applicants: Robert E. Bernert, SR., So. Dartmouth, MA (US); Robert E. Bernert, JR., So. Dartmouth, MA (US)

(72) Inventors: Robert E. Bernert, SR., So. Dartmouth, MA (US); Robert E. Bernert, JR., So. Dartmouth, MA (US)

(21) Appl. No.: 12/587,200

(22) Filed: Oct. 2, 2009

Related U.S. Application Data
(60) Provisional application No. 61/195,599, filed on Oct. 8, 2008.

(51) Int. Cl. F17C 9/02; F28D 1/04; F28F 13/00; F17C 13/00

(52) U.S. Cl. 62/50.2; 62/50.7; 165/157

(57) ABSTRACT

The present invention relates to an improved heat transfer device and process, such as the heat exchanger included in a process for vaporizing cryogenic fluids industrial gas supply systems. The system having a water bath and heat exchange tube bundle disposed therein operating to vaporize and superheat industrial liquefied gases including fuel gases. Water contained in a tank transfers heat to the bundle by natural convection without benefit of forced water circulation. The water is heated by means such as steam, combustion processes or electric heat and a heat exchange tube bundle submerged within the water tank is used to vaporize and superheat liquefied gas, which passes within the tubular elements of the heat exchange bundle. Gas bubble agitation is provided by discharging nitrogen, air or other non-condensing gas into the water via a gas-sparging manifold located below the tube bundle for the purpose of increasing the rate of heat exchange from the heated water to the cooler liquefied gas and increasing the useable energy storage capacity of the water during operation when the heating means is shut off.

Applicants claim the benefit of U.S. Provisional Patent Application Ser. No. 61/195,599 filed Oct. 9, 2008.

### FIELD OF THE INVENTION

The present invention generally relates to a heat exchanger apparatus and process for vaporizing cryogenic liquefied gas such as in industrial gas plant back up, which utilize a liquefied gas supply. More particularly, the present invention relates to natural convection water bath vaporizers which are heated by suitable means to vaporize and heat the liquefied gas to ambient temperatures suitable for use, for example to a temperature of about 0° to 60° F.

### BACKGROUND OF THE INVENTION

Cryogenic liquefied industrial gases and fuel gases such as nitrogen and oxygen and liquefied natural gases (LNG) are stored in many locations throughout the world. The gases are stored in cryogenic liquid form rather than as ambient temperature gas form since the volume of the liquid is in the range of 1/1000 times the same weight of gas in gaseous form. At locations where an industrial gas plant supplies gas or where a natural gas pipeline supplies the natural (fuel) gas, a temporary plant backup or LNG peak shave supply of cryogenic liquid is stored and vaporized on demand in case of gas plant shutdown or to augment the pipeline or plant supply in a peak shaving situation. Hence, the vaporization system may be called a plant back-up vaporizer or a peak shave system.

Vaporizers are a class of heat exchangers, which use various heat sources for the vaporization process. Since the vaporized gas generally is discharged from the vaporizers at ambient temperatures, many sources of heat are used such as ambient air, steam, seawater, ambient temperature or heated water. Cryogenic vaporizers may be operated continuously or for shorter periods down to the ½ hour range depending on the overall industrial gas supply process or particular system requirements. The source of vaporizer heat depends upon individual site conditions, space, economics, period of operation and capacity. Prior patent art describes many of the different types of vaporizers, generally named by heat source such as ambient air vaporizer, submerged combustion vaporizers, open-rack sea water vaporizers, steam sparged water bath vaporizers, immersed fire tube water bath vaporizers. The vaporizers may be classed according to service such as continuous, intermittent or ballasted, plant back up or peak-shaving or a combination of these service classes.

Water bath vaporizers are comprised of a water tank or bath into which is submerged a vaporizing coil or tube bundle for the purpose of transferring heat from the water bath to the cryogenic liquid flowing through the tubular coil or tubes of the tube bundle said coil or tube bundle is generally made of austenitic stainless steel due to the cryogenic temperature range of −200° F. to −400° F. Generally, the water transfers the heat via a natural convection heat transfer process as opposed to forced convection, which uses pumping means. It is well known that forced circulation of fluids improves the heat transfer process. In a plant back up situation, the water bath vaporizer is kept heated to a maximum temperature of about 160° F. to prevent the vaporized and superheated gas from exceeding an exit temperature of 160° F. regardless of the rate of gas throughput. At maximum throughput, the exit gas temperature is kept to about 60° F. and in no case lower than the lower limit of approximately 0° F. to avoid pipeline icing conditions. The vaporizer may be operated continuously provided the said water heating means continues to maintain the water bath at the said water temperature of about 160° F. Some of these water bath vaporizers are required to store enough heated water, referred to as thermal ballast, to supply vaporized gas for a certain time period of for example between 15 minutes to one hour in the event of a failure of the heat system, such as loss of steam or loss of electric power, which would shut down the combustion system in fire tube or submerged combustion heating means or any water circulating pumping means. Due to the increasing capacity requirements of these standby vaporizers, with present capacities in the range of heat transfer of 15,000,000 to 30,000,000 Btu/hr and thermal ballast periods of ½ to 1 hour, the physical size of the units, which may require about 20,000 to 40,000 gallons of water storage, presents fabrication, shipping and field erection problems, as well as high cost.

The natural convection water bath heat transfer process is characterized by the Equation:

Q=hAΔT_{w} (Equation 1)

Q being the rate of heat transfer, BTU/hr; h being the water natural convection heat transfer coefficient, BTU/hr ft² ° F., A being the heat exchanger tubular surface area in square feet and ΔT_{w} being the temperature difference between the water and tubular heat exchanger surface in ° F. The thermal energy stored in the water tank is defined as

Q_{w}=W Cp ΔTₛ (Equation 2)

Q_{w} is the heat available in BTU in W lb of water having a specific heat Cp of about 1 BTU/lb ° F. when the water temperature is lowered from T1 to T2° F., rewritten as ΔTₛ the water temperature is reduced during a ballast run without heat being replaced, the natural convection heat transfer coefficient h is reduced and the delta T_{w} (ΔT_{w}) temperature difference is also reduced. Thus combining Equations 1 and 2, it is shown that as the water temperature is reduced, to maintain the heat transfer rate Q in Equation (1), the surface area must be increased since both h and ΔT_{w} are reduced. It is well known by those skilled in the art of cryogenic water bath vaporizers that as the water temperature falls from a bath temperature 160° F. about 120° F. when the heat exchange surface is at 32° F., the freezing point of water, that the heat exchanger surface area A must be increased approximately two times to maintain the rate of heat transfer Q, and a fall from 160° F. to 80° F. requires an increase of heat exchanger surface area A of 3½ to 4 times greater than what is required at a bath temperature of 160° F. A restraint in cryogenic vaporizers is that the extreme low temperature range between −200° F. and −300° F. of the vaporizing cryogenic liquefied gas will produce ice on the heat exchange surface when the surface reaches 32° F. the freezing point of water. Ice layers are known to increase in thickness as the water cools, which can interrupt the heat transfer process and cause system failure by the vaporizer exit gas low temperature shutdown. Natural convection water bath vaporizers produce an ice layer more readily than forced convection water vaporizers. It is also common practice to use alternate fluids other than water, such as glycol (anti-freeze) which alters the water freezing point to a lower value. Such alternates do not change the basic heat transfer process herein.

It is a more recent feature of present art natural convection water bath or alternate liquid bath vaporizers to take particular advantage of the natural thermal stratification within the water bath by placing the vaporizer tube bundle in the uppermost portion of the water bath where the water remains warmer during operation. While a gain in performance is achieved, of about 25% in a particular geometry, trial and error is required to establish such gain for each particular vaporizer configuration.

It will be appreciated from the above that the particular restraints placed on the operation of natural convection-water bath vaporizers including thermal ballast systems and the extreme low temperatures of the cryogenic fluid being vaporized result in very large and very costly systems. Improvements in the heat transfer process, reduction in the icing potential on the heat transfer surface and increasing the temperature range which may be used in the water bath thermal ballast system are highly desired in the art. Such improvements would desirably mitigate the combined reduction in heat transfer coefficient h (Equation 1) and the restrictive temperature drop ΔTₛ (Equation 2) in the thermal ballast system without the use of power compared to the conventional systems described above.

### SUMMARY OF THE INVENTION

Several objectives of this invention follow:

To provide a process and apparatus for vaporizing cryogenic liquefied gas which utilizes heated or ambient temperature water to provide the heat for the vaporization process;

To provide a natural convection water bath vaporizer in combination with a non-condensable and inert gas sparger system and apparatus;

To provide a more compact vaporizing system;

To provide a vaporizer with greater resistance to ice formation;

To provide a thermal ballast water bath vaporizer system to operate continuously when heated and for longer time periods in the thermal ballast mode without the heat source than the prior art;

To provide a water bath vaporizer in combination with a gas bubbler with provisions for confining the sparged gas to the vaporizing tube bundle heat transfer surfaces; and

To provide an improved heat transfer process which requires no power. To provide a process and apparatus to reduce thermal stratification in water bath vaporizers.

These and other objectives of this invention will become apparent from the following detailed description and drawings thereof.

### BRIEF DESCRIPTION OF THE DRAWINGS

In the drawings which illustrate the best mode presently contemplated for carrying out the present invention:

FIG. 1 is a schematic side elevational view of a prior art natural convection water bath vaporizer showing heating means and horizontal tube bundle;

FIG. 2 is a schematic side elevational view of an embodiment of the water bath vaporizer system of the invention showing a standby inert gas supply and gas bubbler system;

FIG. 3 is a sectional view taken along the Line 3-3 of FIG. 2, illustrating one embodiment of the gas bubbler manifold and bubble containment baffles of the present invention; and

FIG. 4 is a sectional view of a horizontal tube bundle with a gas bubbler manifold illustrating the superficial gas velocity profile of the present invention.

### BRIEF DESCRIPTION OF THE INVENTION

The present invention provides a process and apparatus for vaporizing cryogenic liquefied gases and comprises a natural convection heated water bath, which includes an air or inert gas bubble agitation system and gas sparging manifold to improve the natural convection heat transfer process to vaporize and superheat the cryogenic liquefied gas. The gas sparging manifold, positioned below the vaporizer heat exchange tube bundle, which lies immersed in the heated water bath, is supplied with either an external source of inert gas or a gas/air recirculating blower. The use of inert gas of this invention reduces the potential of stress corrosion cracking or SCC, of the austenitic stainless steel of the cryogenic liquid vaporizing tube bundle. Such SCC being, in part, caused by the dissolved oxygen in the water which effect is well known to those skilled in the art.

Important features of this invention are the ability of the process to extract a greater quantity of heat from the water bath upon failure or interruption of the water heating means, to allow the reduction in the surface area of the vaporizer tube bundle coil, and to reduce or eliminate the ice layer thickness on the vaporizer heat transfer surface.

The use of liquids, other than water in the natural convection heat transfer process herein described will likewise benefit from the bubble agitation provided by the present invention.

The invention will be described in more detail with reference to the drawings, which illustrate both the process and the apparatus according to this invention.

### DETAILED DESCRIPTION OF THE PREFERRED EMBODIMENT

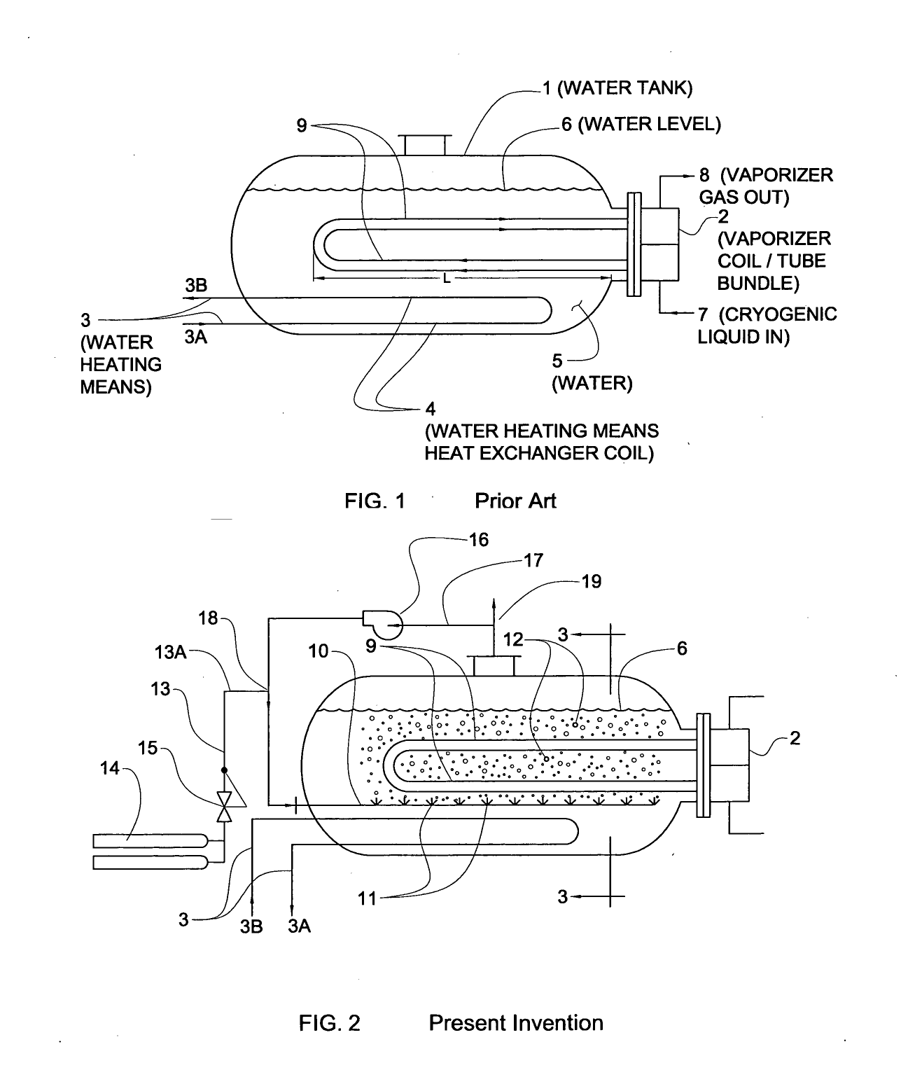

Looking now in greater detail at the accompanying drawings, FIG. 1 illustrates a prior art water bath cryogenic vaporizer. Water bath tank 1 has a natural convection vaporizing tube bundle 2 and a water heating means 3, which flows through water heating means heat exchange coil 4. Said water tank 1 is filled with water 5 to the water level 6 such that the multiplicity of heat transfer tubes 9 of length L and contained in tube bundle 2 are submerged below water level 6. In operation, water heating means 3 such as steam or hot combustion gases, enters coil 4 at 3A, passes through coil 4 in heat exchange process with water 5 and upon cooling exits said means 3 at point 38. Alternatively, steam may be sparged directly into water 5 to provide heat input without benefit of heat exchanger coil 4. Cryogenic liquid to be vaporized and superheated enters vaporizing tube bundle 2 at entry 7, passes through tubes 9, where the cold cryogenic fluid is vaporized and superheated in natural convection heat exchange with water 5 and leaves said tube bundle at exit 8 as superheated gas. It will be appreciated by those skilled in the art of heat transfer that there are many types of tube bundle heat exchangers such as manifold coils, serpentine tube coils and the like, which may be configured to provide the required said surface area A, Equation 1.

The illustrated system is characterized by an oversized water tank which water contained therein acts as a thermal energy storage or ballast to supply heat to the vaporization process for a period of time between 3 to 60 minutes in the event that water heating means 3 malfunctions. Because of this condition, of so called water ballast operation among other considerations, the use of forced convection heat transfer processes to provide a more efficient heat transfer process are not employed. The requirement to employ the low performing natural convection heat transfer process restricts the useable temperature range of the water bath time from the high limit of about 160° F. to the lower limit of about 120° F. where detrimental ice formation on the tube bundle vaporizer tubes and a reduced said natural convection heat transfer coefficient h become significant factors resulting in a large vaporizer tube bundle surface area A from above shown Equation (1) and large thermal water storage requirement Q_{w} from above shown Equation (2).

Now referring to FIG. 2 of the drawings is shown a preferred embodiment of the present invention. In the present invention illustrated in FIG. 2 is shown the prior art natural convection water bath cryogenic liquefied gas vaporizer of FIG. 1 with the addition of an air or inert gas supply and sparger system and process. Gas manifold and sparger 10 of this preferred embodiment is positioned below vaporizer tubes 9 of vaporizer horizontal tube bundle 2.

Compressed inert gas supply 14 flows through pressure regulation 15, passes through gas conduit 13 which is arranged with an anti-siphon loop 13A rising above water level 6 to prevent water 5 from entering gas line 13. Gas from line 13 enters manifold sparger 10 and is ejected into water 5 via a multiplicity of sparger holes 11. The inert gas bubbles streams 12 rise vertically, over and around the tubes 9 of tube bundle 2. Bubbles 12 leave water 5 at water level 6 and exit tank 1 at vent 19. This embodiment uses no power during the vaporization process.

Again referring to inert gas supply 14 (FIG. 2) in the particular case of operation using said thermal ballast for a particular time period or “ballast run time” that said gas supply would be of sufficient volume to provide the required amount of gas bubble agitation during the ballast run operating period.

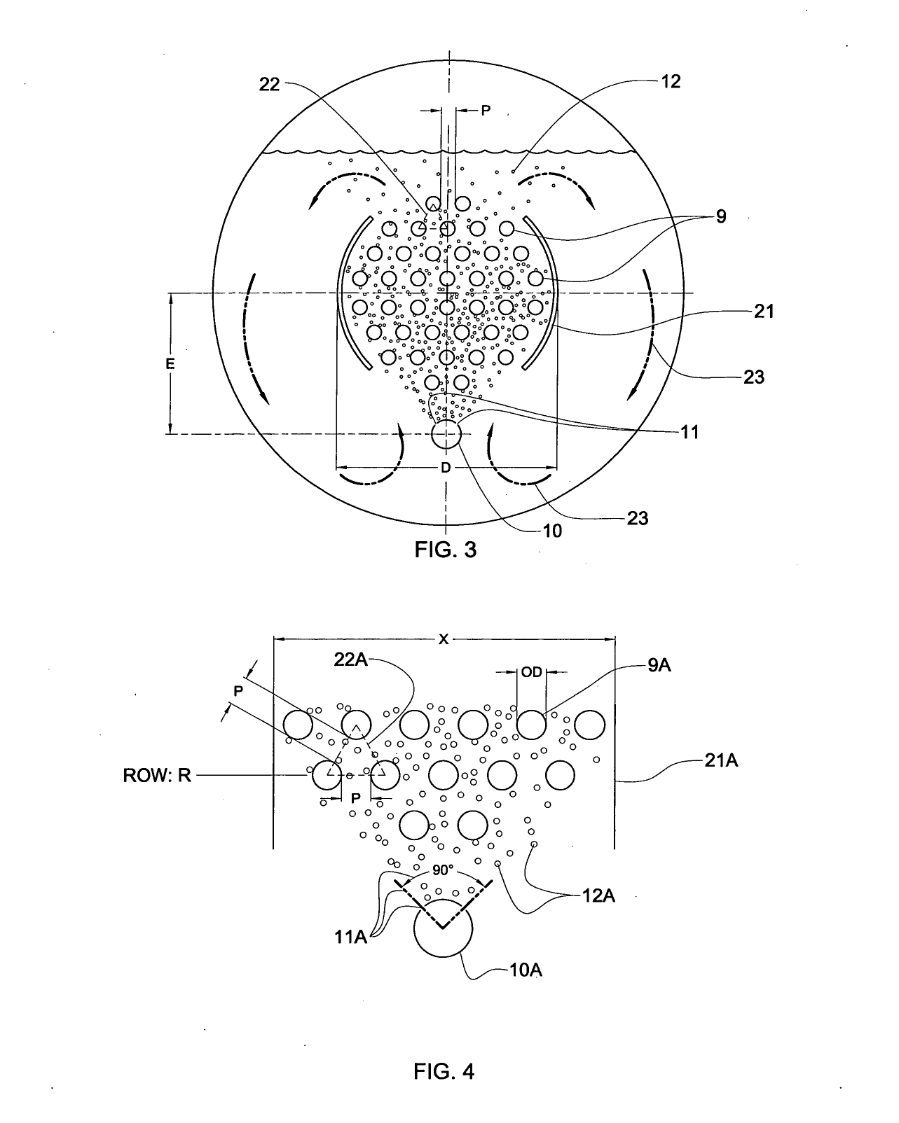

Alternatively, gas may be continuously recirculated by means of gas conduit means or recirculating gas line 17, gas blower 16 and recirculating inert gas connection 18 to said loop 13A. Water heating means 3 may or may not be in operation during the period of gas bubble agitation illustrated in FIG. 2. It has been found that gas bubble agitation of the water bath heat transfer fluid 5 is surprisingly efficient for heat transfer coefficient increase due not only to the vertical velocity component created in the water by the rising bubbles, but more importantly from the radial velocity component created in the water from the intermittent, pulsing action of the rising stream of discrete, individual gas bubbles 12 which discrete bubble stream 12 of rising individual bubbles causes said water to recirculate and rapidly pulsate. It is this rapidly pulsating effect created by the bubble column rising through the water rather than the close proximity of the bubbles to the heat transfer surface that is a major contributor to the enhanced heat transfer coefficient of this invention. FIG. 3 illustrates the positioning of gas manifold 10 of FIGS. 2 and 3 in relationship to tube bundle tubes 9 and further depicts gas bubble confining baffle means 21. In the preferred embodiment illustrated in FIG. 3, gas bubble containment baffles 21 are included, one said baffle on each side of tube bundle tube array of tubes 9. All tube bundle tubes 9 spaced according to tube pitch 22 are contained within tube bundle diameter D. Gas bubble stream 12 emerges from gas manifold 10 through sparger holes 11 and stream upward through the spaces P between regularly spaced tubes 9. Gas manifold 10 is so positioned beneath said tube bundle tubes 9 such that in the preferred embodiment the ratio of the distance E divided by the tube bundle diameter D is between 0.6 and 0.7 or as written E/D=0.6 to 0.7. Rising gas bubbles 12 flowing upward through said water 5, displace a portion of volume of water 5 equal to the particular flowing volume of gas bubbles 12, forcing the so displaced water both vertically upward and outward in a generally horizontal direction, said horizontal direction described above as the radial velocity component. Water that is forced upward forms a circulating current 23 within said water tank 1, which reduces water temperature differences sometimes referred to as thermal stratification within the volume of water 5 thereby maintaining the heat transfer process evenly to each of the multiplicity of vaporizer tubes 9. It is well known to those experienced in the art of cryogenic liquid vaporization, that uneven heat transfer to the vaporizer tubes cause flow maldistribution in the vaporizer causing reduced performance, flow surge and malfunction. Additionally, in some prior art water bath vaporizers, thermal stratification is desirable to reduce ice layer buildup and achieve a higher use of stored thermal energy. Unexpectedly however, the bubble agitated improvement of this invention, while reducing thermal stratification, provides the unobvious results of greater utilization of the thermal ballast potential of the water bath in combination with greater overall heat transfer rates and decreased ice layer buildup provided by the increase in h, Equation (1) of this invention.

Now referring to FIG. 4, it may be described in greater detail the means by which control of the rising volume of gas bubbles relates to the surprising improvement in the heat transfer aspects of the cryogenic water bath vaporizer of the present invention when compared to the prior art natural convection vaporizer heat transfer process. A multiplicity of vaporizing tubes 9A, of length L, as described on FIG. 1 and FIG. 2 are positioned between bubble containment baffles 21A at width X. Tubes 9A are spaced apart a distance P and arranged according to tube pitch 22a. In a preferred embodiment according to FIG. 4, tube pitch 22A is in the form of an equilateral triangle such that tube space P is ½ tube 9A outer diameter OD. Gas distribution manifold 10A containing a multiplicity of sparger holes 11A, said sparger holes, arranged in two rows 90 degrees apart as shown. Said holes are evenly spaced along manifold 10A for said tube length distance L shown above in FIG. 1. The total volume of all gas bubbles 12A rising in a generally upward vertical direction are contained within baffle width X all along said tube length L. As the gas volume of the bubbles streams is increased, they are spread more evenly between baffles 21A along tube length L. The particular upward velocity of the volume of flowing gas bubbles is defined as the superficial gas velocity Vₛ feet per second. Vₛ is defined as the total volume flow of gas in said bubbles in cubic feet per second divided by the available gas bubble flow area A in square feet. The flow area A is defined as the space between tubes in a given R of tubes times tube length L or the number N of tubes 9A in a given tube row R multiplied by tube outside diameter OD and the total N×OD subtracted from baffle width X and then multiplied by said tube length L which may be written as A=[X−(N×OD)]×L square feet. As a method to improve the heat transfer from the water to the vaporizer tube surface, the gas used, such as nitrogen or air, must not be absorbed into the water (or react chemically) as for example steam bubbles which will collapse and condense greatly reducing the improvement of heat transfer coefficient h (Equation 1) over that when using inert gas or air at the same volume when leaving said gas manifold. It is well known in gas to liquid reactors that bubble size and dispersion throughout the reactor are important gas sparging parameters for chemical reaction reasons between the gas and liquid and solid phases. Surprisingly, for heat transfer purpose alone, bubble size and spacing are less important than the superficial gas velocity Vₛ and further that beyond a certain velocity Vₛ, the improvement in the heat transfer due to bubble agitation will decrease. Generally gas velocity Vₛ may vary between 0.002 ft/sec and 2 ft/sec for beneficial effect of this invention, depending upon other considerations.

Since, as described above, that even rates of heat transfer to the heat exchanger tubes and that heat transfer rate is a function of the superficial gas velocity V_{S}, it is beneficial to equalize the velocity V_{S}. Again referring to FIGS. 3 and 4, that the configuration of bubble containment baffles 21 or 21A will affect gas superficial velocity V_{S} as the bubble streams rise upwardly through and around the heat exchanger tubes 9 or 9A. Gas velocity V_{S} may be controlled using curved baffles such as shown as 21, FIG. 3 or other means of tube pitch and baffle arrangements.

### EXAMPLE

The following example illustrates how the present invention achieves a higher rate of heat transfer comparable to present commercial cryogenic natural convection water bath vaporizers providing a lower cost and reduced size of the water ballast systems while at the same time eliminates or greatly reduces ice formation in these cryogenic vaporizers allowing a more compact and lower cost for the vaporizer tube bundle contained in these systems. Referring to FIG. 1, a conventional cryogenic liquefied operating water bath 5 temperature of 160° F. and in combination a thermal ballast operating period of 30 minutes in the event of loss of heating means 3, during which period the average water temperature will drop to 120° F., the point at which ice formation on vaporizer tubes 9 becomes a heat transfer limiting factor. Considering Equation (1) the natural convection transfer rates Q achieved for this prior art system are about 15,000 Btu/hr ft² with the water temperature at 160° F. and is reduced to about 8500 Btu/hr ft² after 30 minutes of operation without heat addition, when from consideration of Equation 2 the average water temperature is lowered to 120° F. The expected ice layer thickness on the tubes is about 0.03 inch, which is provided for, to maintain the natural convection heat transfer process, by using tube pitch P in FIG. 3 of about ½ inch.

Now referring to FIG. 2, a preferred embodiment of the present invention is designed to use inert gas supply system 14, 15, 13 to supply inert or non-condensable gas to manifold 10 and sparger holes 11 to produce the bubble agitated improvement of the heat exchange process of this invention for the purpose of increasing h from Equation 1. Now with reference to FIG. 4, the gas volume ejected from sparger holes 11A is sufficient to produce said superficial velocity V_{S} of about 0.04 ft/sec. Consideration of Equation 1, which with the gas bubble agitation process of this invention now shows that with the water temperature at 160° F., the rate of heat transfer Q becomes about 45000 Btu/hr ft² and is reduced to about 28,000 Btu/hr ft² at 120° F. after 30 minutes of operation without heat source 3 operating. Since, as well understood by those skilled in the art of conductive heat transfer, the ice layer thickness is inversely proportional to the heat transfer rate Q, which will reduce the ice layer thickness by the ratio of the prior art Q of 8500 Btu/hr ft² divided by 28000 Btu/hr ft². The improved heat transfer rate of the present invention at 120° F. or 0.03×8500/28000=0.009 inch ice thickness, illustrating a significant and substantial ice layer thickness reduction of about 67% using this invention.

It can now be understood that by using the heat transfer improvement of this invention that at the same water bath temperature a much reduced heat transfer surface area A from Equation 1 may be used to significantly reduce the size and cost of said vaporizer tube bundle 2. Surprisingly, for the cryogenic water bath vaporizers, which operate for a period of time without the addition of heat to the water bath, that the ice layer thickness is reduced at a particular water temperature, or alternatively a lower water bath temperature may be used. Now considering the ice layer thickness of 0.03 inch in the above example at a natural convection water bath temperature of about 120° F. together with the improvement of heat transfer rate of the present invention, combining the results of equations 1 and 2, it can be determined that a water bath temperature of 70° F. will produce a heat transfer rate of 15,000 Btu/hr ft² and the corresponding thickness of ice remains at about 0.03 inch. The surprising result is that the same tube bundle surface area A from Equation 1 using natural convection heat transfer can be used when the heat source 3 is maintaining water 5 at a temperature of 160° F. and in the absence of heat addition, the water temperature can be allowed to drop to 70° F. using the gas bubble agitation of this invention rather than 120° F. without the advantages of this invention. Consideration of Equation 2 will show that the amount of water W required is inversely proportional to the water temperature drop ΔTs or that for this example 160−120/160−70=0.45 illustrating that the water volume or weight W may be reduced by over 50% for the same ballast operating period without the addition of heat and with no increase in ice layer thickness. Table 1 summarizes these expected values.

TABLE 1

| | | | WITH GAS | | |
|---|---|---|---|---|---|
| | | | BUBBLER | | |
| | | | OF THIS | | % |
| | PRIOR ART | | INVENTION | | GAIN |
| HEAT | | | | | |
| TRANSFER RATE | | | | | |
| WATER AT: | | | | | |
| 160° F. | 15,000 | Btu/hr ft² | 45,000 | Btu/hr ft² | 300% |
| 120° F. | 8,500 | Btu/hr ft² | 28,000 | Btu/hr ft² | 330% |
| 70° F. | NOT PRACTICAL | | 15,000 | Btu/hr ft² | New |
| | | | | | Use |
| | HEAVY ICE | | | | |
| | LAYER | | | | |
| WATER STORED | | | | | |
| ENERGY USE AT | | | | | |
| 0.03 INCH ICE | | | | | |
| LAYER | | | | | |
| 160-120 = ΔT 40 | 40 | Btu/lb | | | |
| 160-70 = ΔT 40 | | | 90 | Btu/lb | 225% |

It is an unexpected advantage of this invention, that when comparing the combination of heat transfer rates made possible over the prior art and the surprising reduction in said ice layer which results during operation of to cryogenic water bath vaporizers that the simple addition of the gas bubbler of this invention to an existing water bath vaporizer would permit either an economic gain due to the increased vaporization capacity when operating between 160° F. and about 120° F. or lower, or it permits a ballast run period increase from 30 minutes where water ΔT_{S} is 40° F. to over 1 hour where the water temperature ΔT_{S} drop is 90° F., greatly increasing the capacity of any existing water-bath vaporizer.

From the above, it will be appreciated that the gas bubble agitated liquid water bath heat exchange process and apparatus of this invention as applied to natural convection heat transfer processes is a highly desirable advance in the art, which never before was appreciated enabling either separately or in combination enhanced heat transfer and reduction in ice layer formation to be achieved in these cryogenic vaporizer systems. The size of the vaporizer tube bundle can thus be reduced and the thermal energy storage capacity of a given volume of water can be increased or a combination of both can be advantageously maximized.

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention. The details of the apparatus and process may be varied substantially without departing from the spirit of the invention, and the exclusive use of all modifications, which come within the scope of the appended claims, is reserved.

What is claimed is:

1. A process for vaporizing cryogenic liquefied gas in a
A. a cryogenic liquefied gas vaporizer having
(a) a water vessel assembly filled with water to a certain water level in the uppermost portion of said water vessel and
(b) a horizontally positioned vaporizer tube bundle located in the uppermost part of the said vessel said vaporizer tube bundle comprised of evenly spaced, horizontally positioned heat transfer tubes positioned such that said tubes are submerged below said surface of said water level and
(c) a water heating means located in the lower most portion of said water containing vessel and
(d) a non-condensable gas manifold conduit means, said manifold positioned beneath said vaporizer tube bundle and said manifold containing one or more rows of evenly spaced gas sparging holes for introducing streams of vertically rising gas bubbles at a superficial gas velocity Vs of 0.002 feet per second or greater into the water surrounding said tube bundle tubes for the purpose of improving heat transfer;
said process comprising
B. providing a cryogenic liquefied gas which flows within the tubes of said vaporizer tube bundle and
C. vaporizing and superheating said liquefied gas and
D. providing an inert, pressurized gas to said gas manifold for the purpose of creating multiple streams of vertically rising gas bubbles.

2. The process of claim 1 further comprising providing a baffle means on each side of said horizontally positioned vaporizer tube bundle for containing said rising gas bubble streams to within the spaces between said tubes of said tube bundle.

3. The process of claim 2 providing said baffle means as curved, circular elements for the purpose of maintaining a constant superficial gas velocity rising through and around all tubes of said tube bundle.

4. The process of claim 1 further comprising a sufficient volume of said water acting as thermal ballast to provide heat for vaporization for an extended time period without said water heating means supply.

5. The process of claim 1 further comprising providing a gas blower and conduit means for non-condensable gas recirculation with said rising gas bubbles collected above said water level in said water tank, passing through said blower to said inert gas manifold.

6. The process of claim 1 further comprising providing an inert non-condensable gas supply of sufficient quantity to provide said inert gas to said gas manifold during an extended period of time without the use of electric power or other mechanical means.

7. The process of claim 1 wherein said superficial gas velocity Vs of said multiple streams of rising non-condensable gas bubbles is from about 0.002 feet per second to about 0.02 feet per second.

8. The process of claim 1 wherein said superficial gas velocity Vs of said multiple streams of rising non-condensable gas bubbles is from about 0.02 feet per second to 0.2 feet per second.

9. The process of claim 1 wherein said superficial gas velocity Vs of said multiple columns of rising non-condensable gas bubbles is from about 0.2 feet per second to about 2 feet per second.

10. The process of claim 1, which provides locating of the gas sparging manifold below the vaporizer tube bundle wherein the ratio E/D, the distance E divided by the tube bundle diameter D is between 0.6 and 0.7.

11. A device for vaporizing cryogenic liquefied gas having
A. a cryogenic liquefied gas vaporizer having
(a) a water vessel assembly filled with water to a certain water level in the uppermost portion of said water vessel and
(b) a horizontally positioned vaporizer tube bundle located in the uppermost part of said vessel, said vaporizer tube bundle comprised of evenly spaced, horizontally positioned heat transfer tubes positioned such that said tubes are submerged below said surface of said water level and
(c) a water heating means located in the lower most portion of said water containing vessel and
(d) a non-condensable gas manifold conduit means, said manifold positioned beneath said vaporizer tube bundle and said manifold containing one or more rows of evenly spaced gas sparging holes for introducing steams of vertically rising gas bubbles at a superficial gas velocity Vs of 0.002 feet per second or greater into the water surrounding said tube bundle tubes.

12. The device as defined in claim 11 which includes a means to supply an inert, pressurized gas to said gas manifold for the purpose of creating multiple streams of vertically rising gas bubbles.

13. The device as defined in claim 11 further comprising a baffle means on each side of said horizontally positioned vaporizer tube bundle for containing said rising gas bubble streams to within the spaces between said tubes of said tube bundle.

14. The device of claim 13 wherein said baffle means are curved, circular elements for the purpose of maintaining a constant superficial gas velocity to all tubes of said tube bundle.

15. The device of claim 11 further comprising a sufficient volume of said water acting as thermal ballast to provide heat for vaporization for an extended time period without said water heating means supply.

16. The device of claim 11 further provided with a gas blower and conduit means for non-condensable gas recirculation with said gas collected above said water level in said water tank, passing through said blower to said gas manifold.

17. The device of claim 11 further comprising providing a non-condensable gas supply of sufficient quantity to provide gas to said gas manifold during an extended period of time.
